(19) United States
(12) Patent Application Publication
(10) Pub. No.: US 2024/0296357 A1
(43) Pub. Date: Sep. 5, 2024

(54) METHOD AND DEVICE FOR THE AUTOMATED CREATION OF A MACHINE LEARNING SYSTEM FOR MULTI-SENSOR DATA FUSION

(71) Applicant: Robert Bosch GmbH, Stuttgart (DE)

(72) Inventors: Benedikt Sebastian Staffler, Muenchen (DE); Jan Hendrik Metzen, Boeblingen (DE)

(21) Appl. No.: 18/574,913

(22) PCT Filed: Aug. 1, 2022
(86) PCT No.: PCT/EP2022/071570

§ 371 Date: Dec. 28, 2023

(30) Foreign Application Priority Data
Aug. 10, 2021 (DE) 10 2021 208 724.8

(51) Int. Cl. G06N 7/01; G06V 10/84

(52) U.S. Cl. CPC G06N 7/01; G06V 10/84

(57) ABSTRACT

A method for creating a machine learning system, which can be configured for segmentation and object detection. The method includes: providing a directed graph, selecting one or more paths through the graph, wherein at least one additional node is selected from a subset, and a path through the graph from an input node along the edges via the additional node to an output node is selected; finding the optimal input nodes from a plurality of input nodes for each output of the directed graph.

### FIELD

The present invention relates to a method for creating a machine learning system, for example for segmentation and/or object detection, wherein the machine learning system carries out multi-sensor data fusion to ascertain its output variables, to a corresponding computer program, and a machine-readable storage medium with the computer program.

### BACKGROUND INFORMATION

The goal of an architecture search for neural networks is to fully automatically find the best possible network architecture in the sense of a performance indicator/metric for a specified data set.

In order to make the automatic architecture search computationally efficient, various architectures in the search space can share the weights of their operations, as, for example, in a one-shot NAS model shown by Pham, H., Guan, M. Y., Zoph, B., Le, Q. V., & Dean, J. (2018), “Efficient neural architecture search via parameter sharing,” arXiv preprint arXiv:1802.03268.

In this case, the one-shot model is typically constructed as a directed graph, in which the nodes represent data and the edges represent operations, representing a calculation rule, which transition the input node of the edge into the output node. The search space in this case consists of subgraphs (e.g., paths) in the one-shot model. Since the one-shot model can be very large, individual architectures can be drawn, in particular randomly, from the one-shot model for the training, as, for example, shown by Cai, H., Zhu, L., & Han, S. (2018), “ProxylessNAS: Direct neural architecture search on target task and hardware,” arXiv preprint arXiv:1812.00332. This typically takes place in that a single path is drawn from a defined input node to an output node of the network, as, for example, shown by Guo, Z., Zhang, X., Mu, H., Heng, W., Liu, Z., Wei, Y., & Sun, J. (2019), “Single path one-shot neural architecture search with uniform sampling,” arXiv preprint arXiv:1904.00420.

For particular tasks such as object detection or in multi-task networks, it is necessary for the network to have several outputs. Gradient-based training of the entire one-shot model can be modified for this case, as, for example, shown by Chen, W., Gong, X., Liu, X., Zhang, Q., Li, Y., & Wang, Z. (2019), “FasterSeg: Searching for Faster Real-time Semantic Segmentation,” arXiv preprint arXiv:1912.10917. However, this in turn is not memory-efficient and does not show the drawing of architectures with branches and with different outputs during the training as part of the architecture search.

Authors Cai et al. described in their paper “ProxylessNAS: Direct Neural Architecture Search on Target Task and Hardware,” retrievable online: https://arxiv.org/abs/1812.00332, an architecture search that takes hardware properties into account.

However, the conventional architecture searches with one-shot models have the limitation that they cannot optimize over a plurality of possible input nodes. Of interest are, however, several inputs, for example in connection with several different sensors, which can provide complementary information.

### SUMMARY

The present invention improves the architecture search in two ways. On the one hand, the present invention makes it possible to find an optimal input or a plurality of optimal inputs. For example, this allows fusing the data of several sensors and automatically learning the depth of the architecture at which the information of different sensors should be combined (early, intermediate or late fusion).

Furthermore, the present invention makes it possible to optimize structures of detection heads, which can be attached to so-called nodes of interest (NOIs). It is thus also possible to optimize the architecture via the outputs.

In a first aspect, the present invention relates to a computer-implemented method for creating a machine learning system for sensor data fusion. According to an example embodiment of the present invention, for this purpose, the machine learning system comprises a plurality of inputs for the sensor data. The sensor data, in particular the sensor data provided to the inputs, come from a plurality of identical sensor types, which, for example, sense sensor data from different perspectives, and/or from different sensor types and thus provide different information to the machine learning system.

According to an example embodiment of the present invention, the method comprises the following steps: providing a directed graph, wherein the directed graph comprises a plurality of input nodes and at least one output node and a plurality of further nodes. The output node can be a fixed node of the graph that is not connected to any further subsequent node. Alternatively, the output node can also be any node from a specified subset of the nodes of the graph, which are suitable as output nodes, for example due to their data resolution. The input and output nodes are connected via the further nodes by means of directed edges. The nodes can represent data and the edges can represent operations that transition a first node of the edges into a further node connected to the respective edge. It should be noted that this assignment of the data and calculation rules can also take place vice versa. The edges are respectively assigned a probability, which characterizes the probability with which the respective edge is drawn. It should be noted that, alternatively, an assignment of the probabilities of the nodes is possible. A normalization of the probabilities of the edges should take place in such a way that adding up all probabilities of the edges originating from a common node results in the value one.

According to an example embodiment of the present invention, the input nodes are also respectively assigned a probability. These probabilities characterize the probability with which the input nodes are drawn. Preferably, this probability is normalized so that summing up the individual probabilities of the input nodes results in the value one. It is possible for the directed graph to have a plurality of output nodes. In this case, the probabilities can be defined depending on the respective node and, summed up over a subset of the input nodes, can, for example, also already result in the value one. In other words, the probabilities of the input nodes can be defined as conditional probabilities for a given output node. This has the result that, depending on the output nodes, not every input node is used. This implies that, depending on the output node selected, different probabilities can be assigned to each input node. Moreover, it is possible that several input nodes can also be drawn for a given output node, wherein the probabilities for this purpose can be defined via pairs/triplets, etc. of input nodes.

Thereafter, selecting one or more paths through the graph follows. For this purpose, one or at least two input nodes are drawn, in particular randomly, from the plurality of input nodes depending on the probabilities assigned to the input nodes. It is possible that drawing can take place depending on the output node. The paths are respectively selected from the drawn input node along the edges to the output node depending on the probability assigned to the edges. It is also possible that only one input node, and thus only one path, is drawn. Thus, the optimal input node can be selected from the plurality of input nodes.

According to an example embodiment of the present invention, selecting the path can take place iteratively, wherein, at each node, the subsequent edge is selected randomly from the possible subsequent edges connected to this node, depending on the assigned probabilities thereof. This procedure is also referred to below as drawing the path. The path thus represents a direct connection of the input node to the output node. Drawing the path can take place by a forward-directed drawing, starting at the drawn input node by means of stepwise drawing of the edges, or by a backward-directed drawing, starting at the output node by means of stepwise drawing backward along the edges.

Here, the path can be understood to mean a sequence of selected nodes of the directed graph, in which sequence two successive nodes are in each case connected by an edge. The path can in this case fully characterize the architecture if the architecture has only one path through the directed graph. It is also possible that the path describes only a portion of the architecture, namely, if the architecture has several paths through the graph. The several paths then together form a subgraph, which effectively describes at least two crossing paths or one path splitting into two paths, through the graph. However, the subgraph can also have only one path, wherein this path then fully describes the subgraph.

Thereafter, according to an example embodiment of the present invention, creating a machine learning system depending on the selected paths and training the created machine learning system follow, wherein adjusted parameters of the trained machine learning system are stored in the corresponding edges of the directed graph and the probabilities of the edges and of the drawn input node of the path are adjusted. The adjustment of the probabilities can in this case take place via a so-called black-box optimizer, which, for example, applies the REINFORCE algorithm (see, for example, the above cited literature “ProxylessNAS” in this respect) in order to estimate gradients for adjusting the probabilities.

Thereafter, according to an example embodiment of the present invention, several repetitions of the previous steps “Selecting the paths” and “Creating and training a machine learning system” follow. Thereafter, a final creation of the machine learning system depending on the directed graph follows. The drawing of the path in the last step can take place randomly, or the edges with the highest probabilities are selected specifically.

According to an example embodiment of the present invention, it is provided that a subset is determined from the plurality of further nodes, all of which satisfy a specified property with regard to a data resolution, wherein at least one additional node (node of interest, NOI), which can serve as a further output node of the machine learning system, is selected from this subset. For an input node and an output node of the path, a first subpath is drawn through the graph from the input node along the edges to the additional node (NOI) and a second subpath is drawn through the graph from the input node along the edges to the output node, or the path is drawn through the graph from the input node along the edges via the additional node (NOI) to the output node. The determination of the subpaths is repeated for each further input and output node.

According to an example embodiment of the present invention, it is furthermore provided that, if the second path meets the already drawn first path, the remaining portion of the first path is used for the second path.

According to an example embodiment of the present invention, it is furthermore provided that the subset of the nodes is divided into sets of additional nodes (NOI). Each additional node (NOI) is assigned a probability, which characterizes the probability with which the node is drawn from the set into which it was divided. When selecting the path from each of the sets, an additional node (NOI) is in each case drawn randomly, and wherein this probability is also adjusted during the training.

According to an example embodiment of the present invention, it is furthermore provided that a plurality of task-specific heads is assigned to each additional node (NOI) or set of additional nodes (NOI). Each task-specific head is assigned a probability, which characterizes the probability with which the task-specific heads are drawn, wherein, during the selection of the path for the task-specific heads, one of the task-specific heads is drawn from a plurality of task-specific heads depending on the probabilities assigned to the task-specific heads.

Task-specific heads can be understood to mean that these heads ascertain an object classification, in particular an object description, depending on the output of the additional node. In other words, the heads comprise at least one node that transforms an output of the additional node (NOI) into a variable that characterizes an input variable of the machine learning system, in particular with regard to a predetermined task or use of the machine learning system. Preferably, the task-specific heads describe a small neural network, e.g., with 2, 3 or 5 layers.

According to an example embodiment of the present invention, it is furthermore provided that the directed graph has a first search space, wherein a resolution of the data, which is respectively assigned to the nodes, is continuously reduced with the number of connected nodes up to one of the input nodes. Furthermore, the graph has a second search space, which comprises the additional nodes (NOIs), wherein sets of additional nodes (NOI) are respectively attached to a node of the first search space.

An advantage here is that so-called FPN architectures can be optimized therewith. The first and second search spaces are directly connected to one another. A search space can be understood to mean a set of nodes that collectively describe a multitude of possible architectures.

According to an example embodiment of the present invention, it is furthermore provided that the outputs of the machine learning system can output a segmentation, object detection, depth estimation, gesture/behavior recognition, and the input nodes can provide the following data: camera images, lidar data, radar data, ultrasonic data, thermal image data, microscopy data, in particular these data from different perspectives.

Preferably, a softmax function is applied to the probabilities, and the edges or corresponding nodes are then drawn randomly depending on the outputs of the softmax function. This has the advantage that the softmax function guarantees that an accumulation of the probabilities always results in the value one. This advantage produces the advantageous effect that the probabilistic character of drawing the paths is retained and an optimal architecture is thus found more reliably.

According to an example embodiment of the present invention, it is furthermore provided that, during the training of the machine learning system, a cost function is optimized, wherein the cost function comprises a first function, which evaluates a performance capability of the machine learning system with regard to the segmentation and object recognition/object description thereof, and comprises a second function, which estimates a latency or the like of the machine learning system depending on a length of the path and on the operations of the edges.

Particularly preferably, according to an example embodiment of the present invention, the machine learning system to be created has at least two outputs configured for segmentation and object detection of images, wherein the machine learning system has an input for receiving the image and two outputs, wherein a first output outputs the segmentation of the image and a second output outputs the object detection. Alternatively, the second output can output a different object description of the objects in the image, such as an object classification.

Additionally, or alternatively, the tasks of the machine learning system can be as follows: natural language processing, autoencoder, generative models, etc., wherein the different outputs respectively characterize different properties of the input signal with regard to the task.

Preferably, the machine learning systems are neural networks.

In further aspects, the present invention relates to a computer program configured to perform the above methods, and to a machine-readable storage medium on which this computer program is stored.

Example embodiments of the present invention are explained in greater detail below with reference to the figures.

### BRIEF DESCRIPTION OF THE DRAWINGS

FIG. 1 schematically shows a one-shot model with several input and output nodes as well as three sets of ‘nodes of interest’ (NOIs), according to an example embodiment of the present invention.

FIG. 2 schematically shows a backward-directed and forward-directed drawing of a path through the one-shot model, according to an example embodiment of the present invention.

FIG. 3 schematically shows a one-shot model for FPT networks, according to an example embodiment of the present invention.

FIG. 4 schematically shows a one-shot model with several input and output nodes, according to an example embodiment of the present invention.

FIG. 5 shows a schematic representation of a flow chart of an embodiment of the present invention.

FIG. 6 shows a schematic representation of an actuator control system, according to an example embodiment of the present invention.

FIG. 7 shows an exemplary embodiment for controlling an at least semiautonomous robot, according the present invention.

FIG. 8 schematically shows an exemplary embodiment for controlling a production system. according to the present invention.

FIG. 9 schematically shows an exemplary embodiment for controlling an access system, according to the present invention.

FIG. 10 schematically shows an exemplary embodiment for controlling a monitoring system, according to the present invention.

FIG. 11 schematically shows an exemplary embodiment for controlling a personal assistant, according to the present invention.

FIG. 12 schematically shows an exemplary embodiment for controlling a medical imaging system, according to the present invention.

FIG. 13 shows a possible structure of a training device, according to the present invention.

### DETAILED DESCRIPTION OF EXAMPLE EMBODIMENTS

In order to find good architectures of deep neural networks for a specified data set, automated methods for architecture search can be used, so-called neural architecture search methods. For this purpose, a search space of possible architectures of neural network is defined explicitly or implicitly.

In the following, for describing a search space, a graph (the so-called one-shot model), which contains all architectures in the search space as subgraphs, is to be defined. Since the one-shot model can be very large, individual architectures can be drawn from the one-shot model for the training. This typically takes place by drawing individual paths from a defined input node to a defined output node of the network.

In order to draw architectures that have branches and several outputs, from a one-shot model, a sampling model, in which the paths are drawn backward through the graph, can be used for the paths. For this purpose, the graph can be transposed or the direction of the edges is reversed. Such a sampling is, for example, described in German Patent Application No. DE 10 2020 208 309.

Additionally, it may be the case that the drawn architectures are to contain one or more nodes of the one-shot model that are not at full depth of the network and are referred to below as NOIs (‘nodes of interest’), as well as an optional output at full depth of the one-shot model. In this case, the creation of the path can also take place by a backward-directed drawing for the NOIs in order to connect the latter to the input.

Additionally, a forward-directed drawing starting from the respective NOI is also carried out in order to find the portion of the path to the output of the one-shot model. As in the backward-directed drawing, the drawing in the forward-directed drawing can be aborted as soon as a path is reached that already leads to the input/output but via a different NOI.

As an alternative to the backward-directed drawing starting at the NOI, a purely forward-directed drawing can take place by drawing, for each NOI, a path from the input to the corresponding NOI. This is achieved in that the drawing is carried out only on the corresponding subgraph, which consists of all nodes that are located on a path from the input of the network to the current NOI as well as all edges of the one-shot model between these nodes.

In order to draw architectures that are to have several input nodes or in which the optimal input node is to be found, from a one-shot model, a sampling model is proposed as follows. This sampling model can then be applied to graphs that have a plurality of input and/or output nodes, to find one or a plurality of nodes as input and/or output nodes, in particular from a specified set of nodes of the graph.

In a first embodiment of the sampling model for selecting paths through the graph with several input/output nodes, a one-shot model is considered, which has several fixed input nodes, wherein, during the search for the optimal architecture, the optimal input node or an optimal combination of input nodes is to be found. Fixed input nodes can be understood to mean that these nodes in the graph always serve as an input and cannot be otherwise repurposed. Furthermore, the first embodiment can be extended in that a specified number of fixed output nodes is defined. Fixed output nodes can be understood to mean that the paths through the graph terminate at one of these output nodes or the paths terminate at all the output nodes, wherein these output nodes in the graph always serve as an output and cannot be otherwise repurposed.

There are thus n₁^{input}, . . . , n_{K}^{input} input nodes in the graph of the one-shot model, wherein K indicates the total number of input nodes. Input nodes are characterized in that they are only connected to subsequent nodes and have no previous nodes.

Furthermore, a set of nodes of interest (NOI) is defined: NOIᵢ=

$$\{ {n}_{1}^{{NOI}_{i}} , … , {n}_{{N}_{i}}^{{NOI}_{i}} \} , i = 1 , … , N .$$

Here N indicates the number of sets of NOIs, Nᵢ is the number of nodes of the NOIs in the set NOIᵢ, and nₖ^{NOI}^{ᵢ} denotes a single node of the graph, which is a NOI. The sets can satisfy a specified property, e.g., with regard to a data resolution or a depth of the nodes relative to the input node, in order to ensure a specified receptive field.

Furthermore, for each set NOIᵢ, a probability distribution pᵢ^{NOI} across all nodes from this set (nₖ^{NOI}^{ᵢ}∈NOIᵢ, k=1, . . . Nᵢ) is defined. Additionally, a further probability distribution p^{inputs}|i,i=1, . . . , M across the input nodes is also defined. Preferably, this further probability distribution p^{inputs} is respectively assigned to an output node i. It is also possible that, depending on the output node, the possible input nodes to be reached are limited to a subset of the input nodes. That is to say, there can be output nodes from which not every input node can/should be reached and which are then, accordingly, not included in the probability distribution p^{inputs}.

The notation g(nₖ^{input}, NOIᵢ) describes a limited one-shot model, which contains all subgraphs that connect an input node nₖ^{input} to every NOI in the set NOIᵢ. For each subgraph g(nₖ^{input}, NOIᵢ), i=1, . . . M, k=1, . . . , Nᵢ, probability distributions are defined, which describe a probability with which the edges and/or nodes are drawn from the subgraph. Preferably, the drawing of a path from the subgraph according to the sample model takes place by a backward-directed drawing from the NOIs to the inputs through g(nₖ^{input}, NOIᵢ).

The probability distributions p^{inputs}|i and pᵢ^{NOI} can be initialized as desired. Preferably, these probabilities are initialized in such a way that the input nodes through p^{inputs}|i are all drawn with the same probability, and that the NOIs within a set are drawn through pᵢ^{NOI} with the same probability. This initialization has the advantage that, at the beginning of the architecture search, the architectures are drawn in an unbiased manner, as a result of which architectures are found that would otherwise not have been found. Particularly preferably, the probability distributions are initialized in such a way that all paths g(nₖ^{input}, NOIᵢ)∈NOIᵢ, starting with the drawing of the NOIs and associated input nodes, are initially drawn with the same probability. This can take place in such a way that the probability distributions are used for initialization depending on a number of the paths along the individual nodes/edges divided by a total number of the paths through the subgraph or graph.

The architectures are then generated in an iterative process by iterating over the sets of the NOIs. For this purpose, a single NOI is drawn from the i-th set depending on the probability distribution pᵢ^{NOI}. Thereafter, one or a plurality of input nodes is drawn depending on the probability distribution p^{inputs}|i. Subsequently, for each drawn input node n^{input}, a path is drawn backward, starting at the drawn individual NOI from the respective set of the NOIs to the corresponding input node, in particular from the subgraph g(n^{input}, NOIᵢ). This procedure is then repeated for each set of the NOIs.

The resulting drawn architecture consists of individual nodes, which were each drawn from one of the sets of the NOIs that are connected via a path to at least one input node.

The sampling model of the first embodiment has the advantage that, by drawing the path in the backward-directed graph, it is significantly more economical in terms of computer resources since the subgraphs can be reused (e.g., for an input and a set of NOIs) for the backward-directed drawing.

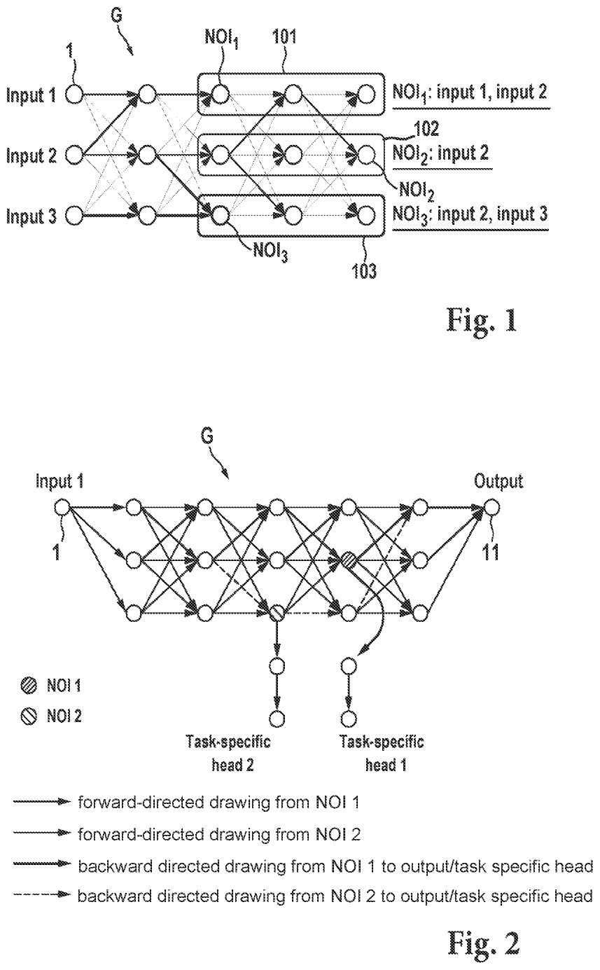

FIG. 1 schematically shows an application of the sampling model to a graph G with several input nodes (1) and several sets of NOIs (101, 102, 103). In this case, from each of the sets of NOIs, an output node is to be learned, as well as the input node (Input1, Input2, Input3) required for this purpose.

The graph G is a representation of a one-shot model, wherein the points correspond to data and the edges correspond to transformations of the data). A particularity in this representation of the graph G is that several input nodes (1) are given and three sets of possible choices for outputs (NOI₁, NOI₂, NOI₃). In order to draw a path, the output nodes (NOI₁, NOI₂, NOI₃) are drawn from the respective set of NOIs (101, 102, 103) randomly, in particular depending on the probability distribution pᵢ^{NOI}. Then, the inputs for each output are drawn (an example of the sampled inputs is shown next to each NOI in FIG. 1). Subsequently, paths for all output nodes to each of its input nodes are drawn successively in the reversed graph.

Preferably, during the drawing of the paths, when previously drawn paths are reached, the previously drawn path is followed to the input. For example, the path starting at NOI₂ meets the path of NOI₃ just before the input node Input2 and then continues along the path of NOI₃ to the input node Input2.

As shown in FIG. 1, one or more or even all the input nodes can be drawn for the output nodes (NOI₁, NOI₂, NOI₃).

The input nodes (Input1, Input2, Input3) can provide or receive the following input data: camera images, lidar data, radar data, ultrasonic data, thermal image data, microscopy data, in particular these data from different perspectives.

In a preferred development of the first embodiment, the following modification can be made. If a further drawn path reaches a node that is contained in one of the previously drawn paths for another set of the NOIs, the further drawn path can continue along the already drawn path. Preferably, the decision as to whether the already existing path is to be used depends on whether this path also leads to the input node that was selected for the NOI of the further path.

In a second embodiment of the sampling model, a one-shot model with a plurality of fixed output nodes and input nodes is considered.

The second embodiment is analogous to the first embodiment but with the difference that the subgraphs are defined between a single output node and all possible choices for an input. Thus, the paths are drawn in the graph instead of the reversed subgraph. More specifically, an input node is first drawn from the corresponding set of possible input nodes, one or more output nodes are then sampled and the input node is connected to each of these output nodes by sampling a path in the subgraph for the current input nodes.

In a third embodiment of the sampling model, a one-shot model is considered, in which both the input node and the output node can be drawn.

The drawing of the paths can proceed from either the input or output nodes, and the path is then, accordingly, drawn forward or backward through the graph.

The sampling models of the embodiments just explained can be combined with one another in order to find complex architectures with several inputs and/or outputs.

A possible extension of the sampling model can be that the sampling model is additionally used for a search for a structure of task-specific heads, see also FIG. 2. These task-specific heads can be attached to the NOIs. For this purpose, the considered one-shot model can be extended by additional nodes/edges, which can be attached to any NOI and correspond to the task-specific heads. The drawing of the path takes place by a first backward-directed drawing, starting at the respective NOIs to the inputs. In particular, this results in a fixed number of sampled NOI nodes. Thereafter, the drawing with respect to all task-specific heads is performed, as well as the drawing of the paths to the output of the graph.

FIG. 2 shows, by way of example, a drawing of task-specific heads for the NOIs with a graph G, which has an input node and an output node.

Paths through the graph G of FIG. 2 can be drawn as described in German Patent Application No. DE 10 2020 208 309, in particular in that the paths are first drawn backward from the respective NOIs to the input and then to the output. Additionally, there is now a further step of the drawing, wherein, for this purpose, drawing takes place from each NOI to the goal of the task-specific heads, which can be attached to any NOI.

In a further embodiment of FIG. 2, the graph G can have a plurality of input and output nodes. For drawing the input nodes, reference is made here to FIG. 1 and, in particular, to FIG. 4.

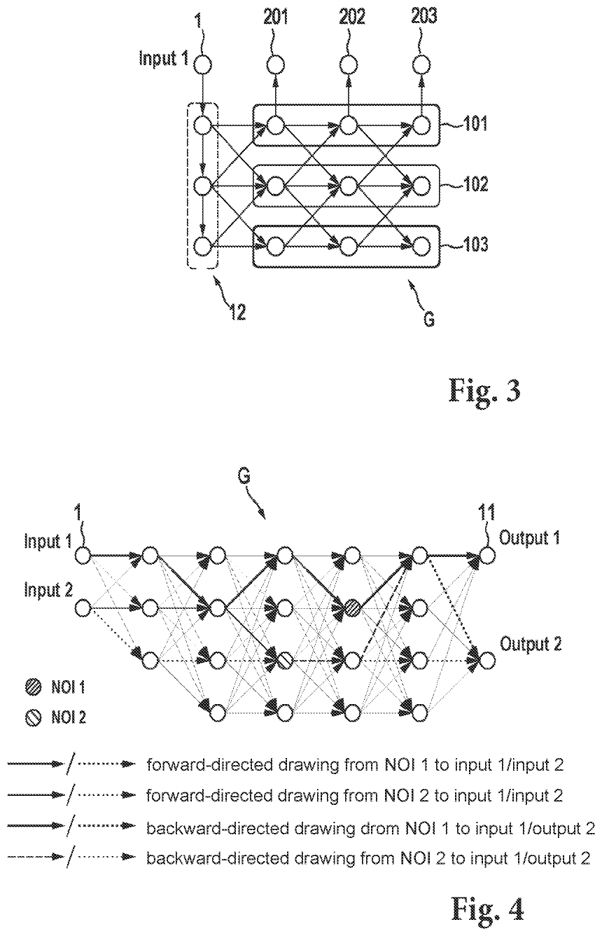

FIG. 3 shows, by way of example, a graph G for an architecture search for a machine learning system with a plurality of sets of the NOIs (101, 102, 103) as well as with a plurality of task-specific heads (201, 202, 203). In FIG. 3, the task-specific heads (201, 202, 203) are, by way of example, assigned to the first set of the NOIs (101). The graph G of FIG. 3 can be used with the sampling model to create so-called FPN networks with a backbone network (12), for example for object detection. FPN networks are, for example, in the paper of the authors Lin, T. Y., Dollár, P., Girshick, R., He, K., Hariharan, B., & Belongie, S., “Feature pyramid networks for object detection” in Proceedings of the IEEE conference on computer vision and pattern recognition (pp. 2117-2125).

Preferably, the graph G of FIG. 3 describes several different search spaces. One of the search spaces is for a backbone network (12) with a series of fixed or searchable output nodes in different resolutions. One of the search spaces is the FPN search space (101-103), which is attached to the backbone network (12) and defines a set of output NOIs. Additionally, task specific heads (201, 202, 203) can be attached to the FPN NOIs. The drawing of the paths in the backbone can take place by backward-directed drawing and, if the backbone is a single-path network, it is sufficient to have only a single NOI at the lowest resolution (maximum depth in the backbone (12)). The drawing from the sets of the NOIs (101, 102, 103) can take place by backward-directed drawing, taking into account the backbone network (12). For the task-specific heads, a forward-directed drawing can be performed, starting from the respective NOI.

It can be said that a 3-step drawing is used for this example.

FIG. 4 shows, by way of example, an architecture search for, in particular, sensor fusion architectures.

The sensor fusion is made possible in that several input nodes corresponding to the different sensor data are considered. In the simplest case, a network with a single output and several inputs with the forward-directed drawing described above can be used. As a result, it can be learned at what depth of the graph the different sensor data are combined, i.e., whether an early, intermediate or late sensor fusion is to be carried out.

The graph G with a plurality of outputs can describe multi-task networks for object detection and semantic segmentation. The NOIs are in this case nodes at which, for example, object detection/classification takes place. Additionally, an output for the semantic segmentation is also used at the output at full depth of the network. Additionally, task-specific heads could be attached to the NOIs.

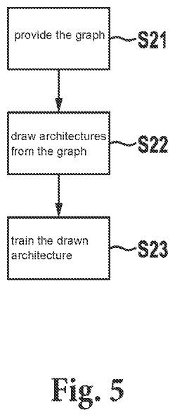

FIG. 5 schematically shows a flow chart of a method for creating a machine learning system with the above-explained procedure for finding the optimal architecture with a plurality of inputs.

The method can begin with step S21, in which the graph G is provided, because the automatic architecture search requires the search space, which is constructed here in the form of a one-shot model G.

Thereafter, step S22 follows. In this step, architectures are drawn from the graph depending on the probabilities as explained with respect to FIG. 1. Thereafter, the conventional steps of training (S23) the drawn architecture and of transferring the optimized parameters and probabilities into the graph by means of the training follow.

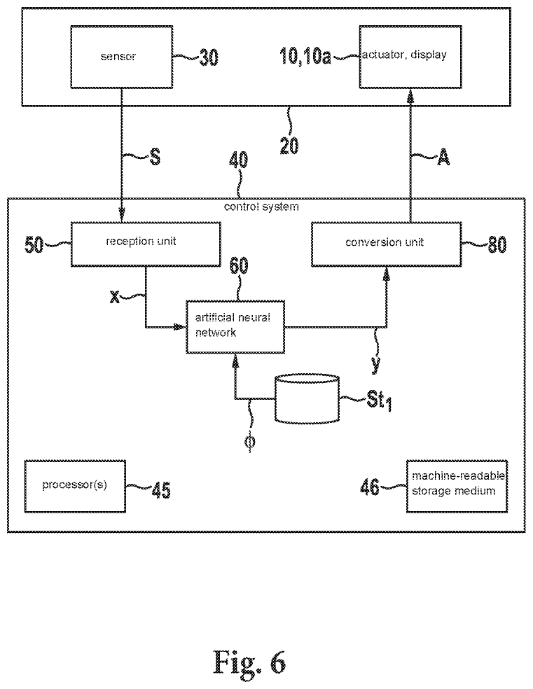

An artificial neural network 60 (shown in FIG. 6) can then be created from the graph G and can be used as explained below.

FIG. 6 shows an actuator 10 in its environment 20 in interaction with a control system 40. At preferably regular intervals, the environment 20 is sensed by means of a sensor 30, in particular an imaging sensor, such as a video sensor, which can also be given by a plurality of sensors, e.g., a stereo camera. Other imaging sensors are also possible, such as radar, ultrasound, or lidar. A thermal imaging camera is also possible. The sensor signal S of the sensor 30, or one sensor signal S each in the case of several sensors, is transmitted to the control system 40. The control system 40 thus receives a sequence of sensor signals S. The control system 40 ascertains therefrom control signals A, which are transmitted to the actuator 10.

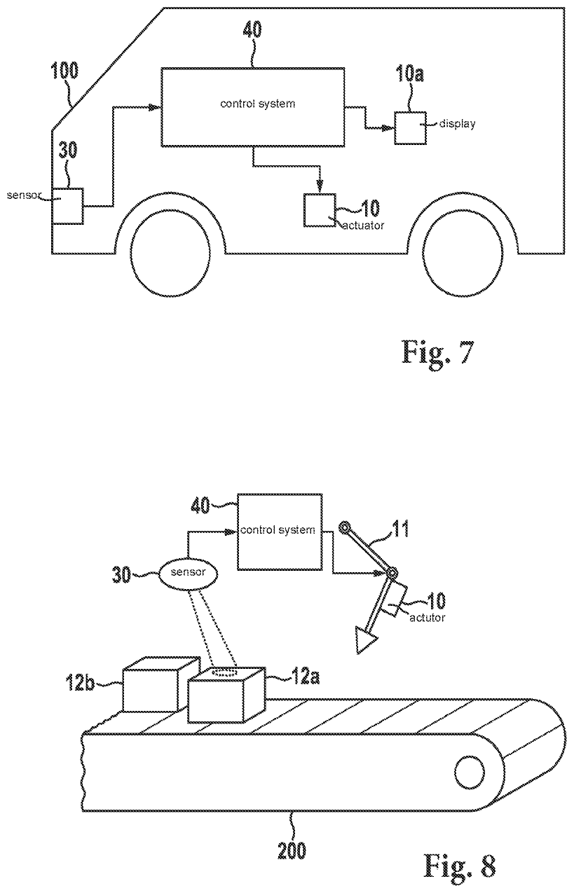

The control system 40 receives the sequence of sensor signals S of the sensor 30 in an optional reception unit 50, which converts the sequence of sensor signals S into a sequence of input images x (alternatively, the sensor signal S can also respectively be directly adopted as an input image x). For example, the input image x can be a section or a further processing of the sensor signal S. The input image x comprises individual frames of a video recording. In other words, input image x is ascertained depending on the sensor signal S. The sequence of input images x is supplied to a machine learning system, an artificial neural network 60 in the exemplary embodiment, which was, for example, created according to the method of FIG. 7.

The artificial neural network 60 is preferably parameterized by parameters ϕ stored in and provided by a parameter memory P.

The artificial neural network 60 ascertains output variables y from the input images x. These output variables y may in particular comprise a classification and semantic segmentation of the input images x. Output variables y are supplied to an optional conversion unit 80, which therefrom ascertains control signals A, which are supplied to the actuator 10 in order to control the actuator 10 accordingly. Output variable y comprises information about objects that were sensed by the sensor 30.

The actuator 10 receives the control signals A, is controlled accordingly and carries out a respective action. The actuator 10 can in this case comprise a (not necessarily structurally integrated) control logic which, from the control signal A, ascertains a second control signal that is then used to control the actuator 10.

In further embodiments, the control system 40 comprises the sensor 30. In still further embodiments, the control system 40 alternatively or additionally also comprises the actuator 10.

In further preferred embodiments, the control system 40 comprises a single or a plurality of processors 45 and at least one machine-readable storage medium 46 in which instructions are stored that, when executed on the processors 45, cause the control system 40 to perform the method according to the present invention.

In alternative embodiments, as an alternative or in addition to the actuator 10, a display unit 10a is provided.

FIG. 7 shows how the control system 40 can be used to control an at least semiautonomous robot, here an at least semiautonomous motor vehicle 100.

The sensor 30 may, for example, be a video sensor preferably arranged in the motor vehicle 100.

The artificial neural network 60 is configured to reliably identify objects from the input images x.

The actuator 10 preferably arranged in the motor vehicle 100 may, for example, be a brake, a drive, or a steering of the motor vehicle 100. The control signal A can then be ascertained in such a way that the actuator or actuators 10 is controlled in such a way that, for example, the motor vehicle 100 prevents a collision with the objects reliably identified by the artificial neural network 60, in particular if they are objects of particular classes, e.g., pedestrians.

Alternatively, the at least semiautonomous robot may also be another mobile robot (not shown), e.g., one that moves by flying, swimming, diving, or walking. For example, the mobile robot may also be an at least semiautonomous lawnmower or an at least semiautonomous cleaning robot. Even in these cases, the control signal A can be ascertained in such a way that drive and/or steering of the mobile robot are controlled in such a way that the at least semiautonomous robot, for example, prevents a collision with objects identified by the artificial neural network 60.

Alternatively, or additionally, the control signal A can be used to control the display unit 10a and, for example, to display the ascertained safe areas. It is also possible, for example in the case of a motor vehicle 100 with non-automated steering, that the display unit 10a is controlled with the control signal A to output an optical or acoustic warning signal if it is ascertained that the motor vehicle 100 is at risk of colliding with one of the reliably identified objects.

FIG. 8 shows an exemplary embodiment in which the control system 40 is used to control a production machine 11 of a production system 200 by controlling an actuator 10 controlling said production machine 11. For example, the production machine 11 may be a machine for punching, sawing, drilling and/or cutting.

The sensor 30 may then, for example, be an optical sensor that senses properties of manufacturing products 12a, 12b, for example. It is possible that these manufacturing products 12a, 12b are movable. It is possible that the actuator 10 controlling the production machine 11 is controlled depending on an assignment of the sensed manufacturing products 12a, 12b so that the production machine 11 accordingly carries out a subsequent processing step of the correct one of the manufacturing products 12a, 12b. It is also possible that, by identifying the correct properties of the same one of the manufacturing products 12a, 12b (i.e., without misassignment), the production machine 11 accordingly adjusts the same production step for processing a subsequent manufacturing product.

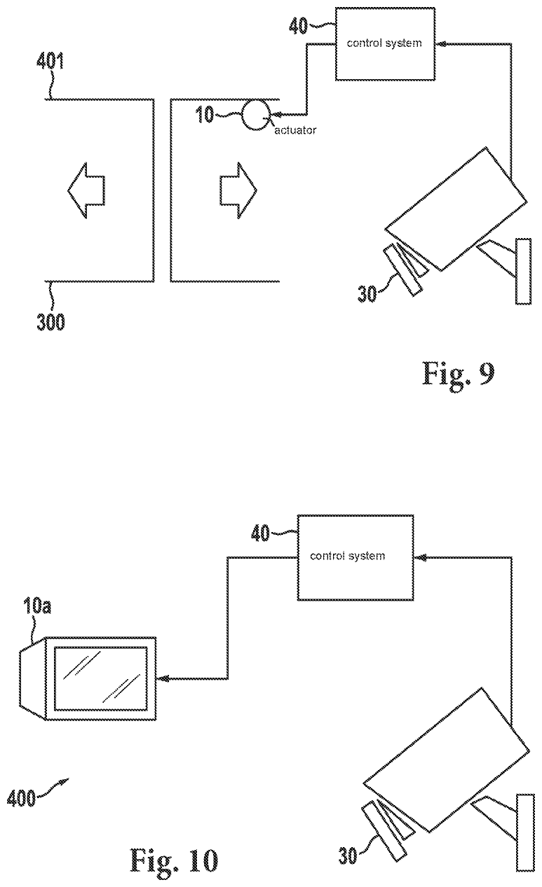

FIG. 9 shows an exemplary embodiment in which the control system 40 is used to control an access system 300. The access system 300 may comprise a physical access control, e.g., a door 401. Video sensor 30 is configured to sense a person. By means of the object identification system 60, this sensed image can be interpreted. If several persons are sensed simultaneously, the identity of the persons can be ascertained particularly reliably by associating the persons (i.e., the objects) with one another, e.g., by analyzing their movements. The actuator 10 may be a lock that, depending on the control signal A, releases the access control, or not, for example, opens the door 401, or not. For this purpose, the control signal A can be selected depending on the interpretation of the object identification system 60, e.g., depending on the ascertained identity of the person. A logical access control may also be provided instead of the physical access control.

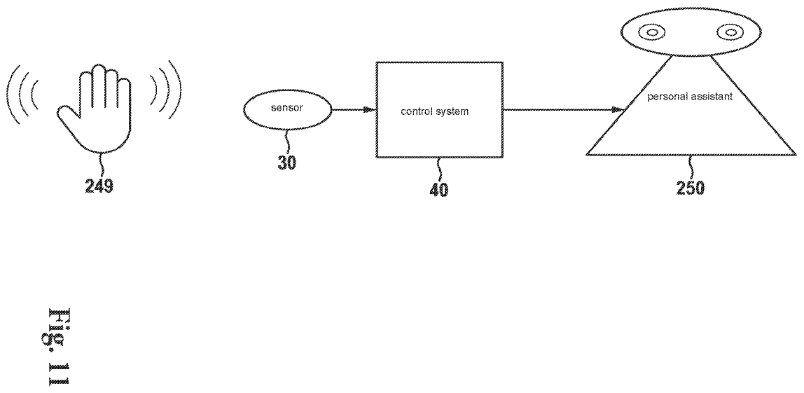

FIG. 10 shows an exemplary embodiment in which the control system 40 is used to control a monitoring system 400. From the exemplary embodiment shown in FIG. 5, this exemplary embodiment differs in that, instead of the actuator 10, the display unit 10a is provided, which is controlled by the control system 40. For example, the artificial neural network 60 can reliably ascertain an identity of the objects captured by the video sensor 30, in order to, for example, infer depending thereon which of them are suspicious, and the control signal A can then be selected in such a way that this object is shown highlighted in color by the display unit 10a.

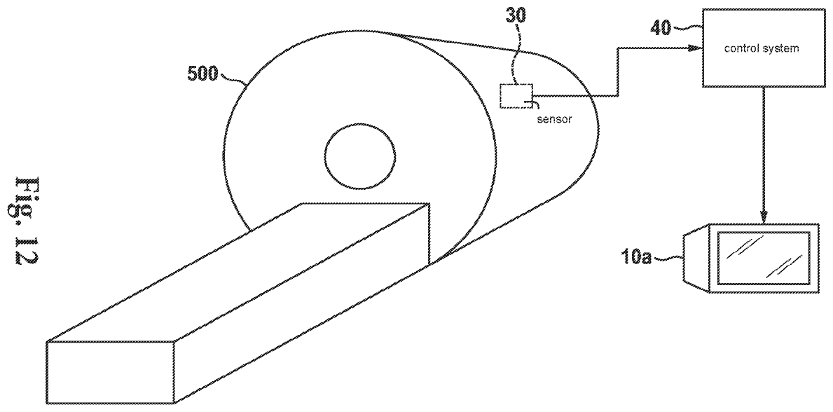

FIG. 11 shows an exemplary embodiment in which the control system 40 is used to control a personal assistant 250. The sensor 30 is preferably an optical sensor that receives images of a gesture of a user 249.

Depending on the signals of the sensor 30, the control system 40 ascertains a control signal A of the personal assistant 250, e.g., in that the neural network performs gesture recognition. This ascertained control signal A is then transmitted to the personal assistant 250 and the latter is thus controlled accordingly. This ascertained control signal A can in particular be selected to correspond to a presumed desired control by the user 249. This presumed desired control can be ascertained depending on the gesture recognized by the artificial neural network 60. Depending on the presumed desired control, the control system 40 can then select the control signal A for transmission to the personal assistant 250 and/or select the control signal A for transmission to the personal assistant according to the presumed desired control 250.

This corresponding control may, for example, include the personal assistant 250 retrieving information from a database and receptably rendering it to the user 249.

Instead of the personal assistant 250, a domestic appliance (not shown) may also be provided, in particular a washing machine, a stove, an oven, a microwave or a dishwasher, in order to be controlled accordingly.

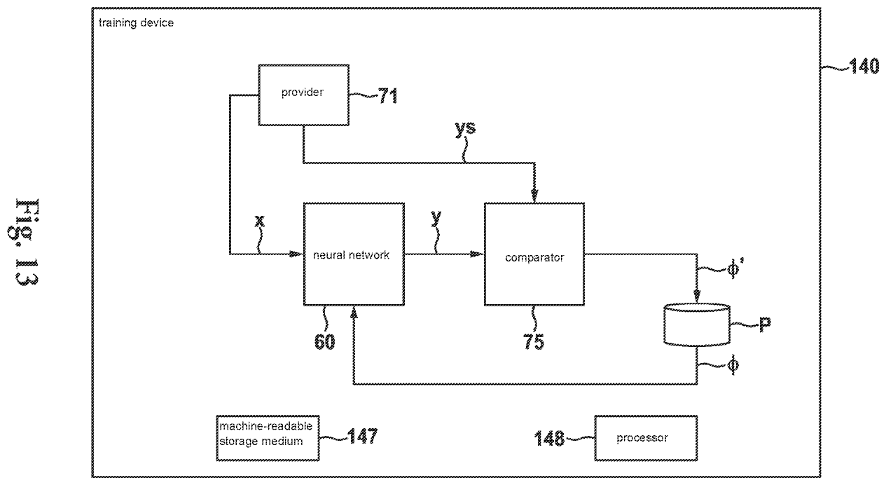

FIG. 12 shows an exemplary embodiment in which the control system 40 is used to control a medical imaging system 500, e.g., an MRT, X-ray, or ultrasound device. For example, the sensor 30 may be given by an imaging sensor, and the display unit 10a is controlled by the control system 40. For example, the neural network 60 may ascertain whether an area captured by the imaging sensor is abnormal, and the control signal A may then be selected in such a way that this area is presented highlighted in color by the display unit 10a.

FIG. 13 shows an exemplary training device 140 for training a drawn machine learning system from the graph G, in particular the corresponding neural network 60. Training device 140 comprises a provider 71, which, for example, provides input images x and target output variables ys, e.g., target classifications. Input image x is supplied to the artificial neural network 60 to be trained, which ascertains output variables y therefrom. Output variables y and target output variables ys are supplied to a comparator 75, which, depending on a match between the respective output variables y and target output variables ys, ascertains new parameters ϕ′, which are transmitted to the parameter memory P and replace parameters ϕ there.

The methods performed by the training system 140 may be stored, implemented as a computer program, in a machine-readable storage medium 147 and may be executed by a processor 148.

Of course, it is not necessary to classify entire images. It is possible that a detection algorithm is used, for example, to classify image sections as objects, that these image sections are then cut out, that a new image section is generated if necessary, and that it is inserted into the associated image in place of the cut-out image section.

The term “computer” includes any device for processing specifiable calculation rules. These calculation rules can be provided in the form of software or in the form of hardware or else in a mixed form of software and hardware.

1-10. (canceled)

11. A computer-implemented method for creating a machine learning system for sensor data fusion, comprising the following steps:
providing a directed graph, wherein the directed graph includes a plurality of input nodes and at least one output node and a plurality of further nodes, wherein the input and output nodes are connected via the further nodes using directed edges,
wherein each respective edge of the edges is respectively assigned a probability, which characterizes a probability with which the respective edge is drawn,
wherein each respective input node of the input nodes is also respectively assigned a probability;
selecting a path through the graph, wherein at least one input node is drawn from the plurality of input nodes depending on the probabilities assigned to the input nodes, wherein the path from the drawn input node along the edges to the output node is selected depending on the probabilities assigned to the edges;
creating a machine learning system depending on the selected path and training the created machine learning system, wherein adjusted parameters of the trained machine learning system are stored in corresponding edges of the directed graph and the probabilities of the edges and of the drawn input node of the path are adjusted;
repeating the selecting, creating, and training steps several times; and
creating the machine learning system depending on the directed graph.

12. The method according to claim 11, wherein the directed graph includes a plurality of output nodes, wherein, when selecting the path, at least one output node is selected from the plurality of output nodes depending on the assigned probabilities of the output nodes, wherein the probabilities assigned to the input nodes depend on the drawn output nodes.

13. The method according to claim 11, wherein a subset is determined from the plurality of further nodes, all of which satisfy a specified property with regard to a data resolution, wherein at least one additional node is selected from the subset, which additional node can serve as a further output node of the machine learning system, wherein, during the selection: (i) a first path is drawn through the graph from the input node along the edges to the additional node and a second path is drawn through the graph from the input node along the edges to the output node or (ii) the path is drawn through the graph from the input node along the edges via the additional node to the output node.

14. The method according to claim 13, wherein the subset of the nodes is divided into sets of additional nodes, wherein each additional node is assigned a probability, which characterizes a probability with which the node from the set into which it is divided is drawn, wherein, when selecting the path, an additional node is respectively drawn randomly from each of the sets, and wherein the probability assigned to the additional nodes is also adjusted during the training.

15. The method according to claim 14, wherein a plurality of task-specific heads is assigned to each additional node or set of additional nodes, wherein each task-specific head is assigned a probability, which characterizes a probability with which the task-specific head is drawn, wherein, when selecting the path, one of the task-specific heads is drawn from a plurality of task-specific heads depending on the probabilities assigned to the task-specific heads, and wherein the probability assigned to the task-specific heads is also adjusted during the training.

16. The method according to claim 11, wherein the directed graph includes a first search space, wherein a resolution of data assigned to the nodes is continuously reduced, wherein the graph includes a second search space, which includes the additional nodes, wherein sets of additional nodes are respectively attached to a node of the first search space.

17. The method according to claim 11, wherein outputs of the machine learning system output a segmentation and/or object detection and/or depth estimation and/or gesture/behavior recognition, and the input nodes provide the following data: camera images and/or lidar data and/or radar data and/or ultrasonic data and/or thermal image data and/or microscopy data, including data from different perspectives.

18. A non-transitory machine-readable storage element on which is stored a computer program for creating a machine learning system for sensor data fusion, the computer program, when executed by a computer, causing the computer to perform the following steps:
providing a directed graph, wherein the directed graph includes a plurality of input nodes and at least one output node and a plurality of further nodes, wherein the input and output nodes are connected via the further nodes using directed edges, wherein each respective edge of the edges is respectively assigned a probability, which characterizes a probability with which the respective edge is drawn,
wherein each respective input node of the input nodes is also respectively assigned a probability;
selecting a path through the graph, wherein at least one input node is drawn from the plurality of input nodes depending on the probabilities assigned to the input nodes, wherein the path from the drawn input node along the edges to the output node is selected depending on the probabilities assigned to the edges;
creating a machine learning system depending on the selected path and training the created machine learning system, wherein adjusted parameters of the trained machine learning system are stored in corresponding edges of the directed graph and the probabilities of the edges and of the drawn input node of the path are adjusted;
repeating the selecting, creating, and training steps several times; and
creating the machine learning system depending on the directed graph.

19. A device configured to create a machine learning system for sensor data fusion, the device configured to:
provide a directed graph, wherein the directed graph includes a plurality of input nodes and at least one output node and a plurality of further nodes, wherein the input and output nodes are connected via the further nodes using directed edges, wherein each respective edge of the edges is respectively assigned a probability, which characterizes a probability with which the respective edge is drawn,
wherein each respective input node of the input nodes is also respectively assigned a probability;
select a path through the graph, wherein at least one input node is drawn from the plurality of input nodes depending on the probabilities assigned to the input nodes, wherein the path from the drawn input node along the edges to the output node is selected depending on the probabilities assigned to the edges;
create a machine learning system depending on the selected path and training the created machine learning system, wherein adjusted parameters of the trained machine learning system are stored in corresponding edges of the directed graph and the probabilities of the edges and of the drawn input node of the path are adjusted;
repeat the selecting, creating, and training steps several times; and
create the machine learning system depending on the directed graph.
